(19) United States
(12) Patent Application Publication
(10) Pub. No.: US 2014/0215363 A1
(43) Pub. Date: Jul. 31, 2014

(54) INPUT DISPLAY DEVICE

(71) Applicant: JVC KENWOOD Corporation, Yokohama-shi (JP)

(72) Inventor: Yuji TANAKA, Yokohama-shi (JP)

(73) Assignee: JVC KENWOOD Corporation, Yokohama-shi (JP)

(21) Appl. No.: 14/170,184

(22) Filed: Jan. 31, 2014

(30) Foreign Application Priority Data
Jan. 31, 2013 (JP) 2013-016776

(51) Int. Cl. G06F 3/0488; G06F 3/0484; G06F 3/041

(52) U.S. Cl. CPC G06F 3/0488; G06F 3/041; G06F 3/04845
USPC 715/764; 345/173

(57) ABSTRACT

According to an embodiment, provided is an input display device that includes: a display unit configure to display an image in a front surface thereof; a detection unit configured to be provided on an outer circumference of the display unit; and an input determination unit configured to determine a detected position detected by the detection unit is changed whether in a posterior direction from a side of the front surface of the display unit to a side of a back surface of the display unit, or in an anterior direction from the side of the back surface to the side of the front surface.

### CROSS-REFERENCE TO RELATED APPLICATIONS

The present application claims priority to and incorporates by reference the entire contents of Japanese Patent Application No. 2013-016776 filed in Japan on Jan. 31, 2013.

### BACKGROUND OF THE INVENTION

1. Field of the Invention

The present invention relates to an input display device in which a touch sensor is installed.

2. Description of the Related Art

Conventionally, a touch sensor is installed in the liquid crystal monitors, or the like, of cameras (for example, see Japanese Patent Application Laid-open No. 2009-55622). Furthermore, a touch sensor is installed in the liquid crystal monitors of, for example, terminals that are dedicated to browsing of electronic books that have started to become popular in recent years, or multifunctional terminals that enable browsing of websites and mailing operations. Moreover, a display device called a Head Up Display (HUD) is installed in aircraft display devices, car navigation systems, or the like. In the HUD, a projection light with which a displayed image is projected is incident on a lens and is reflected by a display unit (combiner), whereby a user can view the displayed image due to the reflected light. Here, if a touch sensor is provided on a display unit of the HUD, the projection light is blocked while the touch sensor is manipulated. Therefore, in order to prevent the projection light from being blocked during being manipulated, it can be thought to provide a touch sensor on the outer circumference surface of the display unit instead of the front surface thereof.

For convenience of design, a touch sensor is sometimes provided on the outer circumference surface of the display unit rather than the front surface thereof also in the liquid crystal monitors as well as the HUDs. However, if the image of a button, or the like, is displayed on the outer circumference surface, it is difficult to view the image and therefore the operational performance is decreased. Thus, it can be thought to configure an operational input (gestural input) by gestures in a non-contact manner by using a high-sensitive capacitive touch sensor.

If a touch sensor is provided on the outer circumference surface, it is possible to detect successive changes in the capacitance when gestures are input in the longitudinal direction of a sensor area, i.e., the longitudinal direction of the outer circumference surface of the display unit. For example, the displayed image is moved horizontally or vertically in response to a gestural input in the longitudinal direction. However, by gestural inputs in the longitudinal direction, it is difficult to perform an operation in an intuitive way in a front-back direction (in an anterior direction relative to the screen and in a posterior direction relative to the screen) such as an operation to zoom in or out on the displayed image. Furthermore, although a sensor area needs to be provided in the front-back direction, it is restricted by the width of the outer circumference surface of the display unit in the anterior direction, and therefore it is difficult to detect the direction of an operation.

### SUMMARY OF THE INVENTION

There is a need to at least partially solve the problems in the conventional technology.

According to an embodiment, provided is an input display device that includes: a display unit configure to display an image in a front surface thereof; a detection unit configured to be provided on an outer circumference of the display unit; and an input determination unit configured to determine a detected position detected by the detection unit is changed whether in a posterior direction from a side of the front surface of the display unit to a side of a back surface of the display unit, or in an anterior direction from the side of the back surface to the side of the front surface.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a functional block diagram that schematically illustrates an input display device;

FIG. 2 is an explanatory diagram that illustrates image formation of a virtual image by using a display mechanism;

FIG. 3 is an explanatory diagram that illustrates the arrangement of detection units in the display unit;

FIGS. 4A to 4C are explanatory diagrams that illustrate a gestural input; and

FIG. 5 is a flowchart that illustrates the process flow of an input determination method.

### DETAILED DESCRIPTION OF THE PREFERRED EMBODIMENTS

Preferred embodiments of the present invention are explained in detail below with reference to the accompanying drawings. The sizes, materials, specific numbers, or the like, described in the present embodiment are given as examples to help understanding, and does not mean limitation if not otherwise specified. In this specification and drawings, the components that have substantially the same function or configuration are denoted by the same reference numeral so as not to be repeatedly explained, and the components that are not directly related to the embodiment are not illustrated in the drawings.

Input Display Device 100

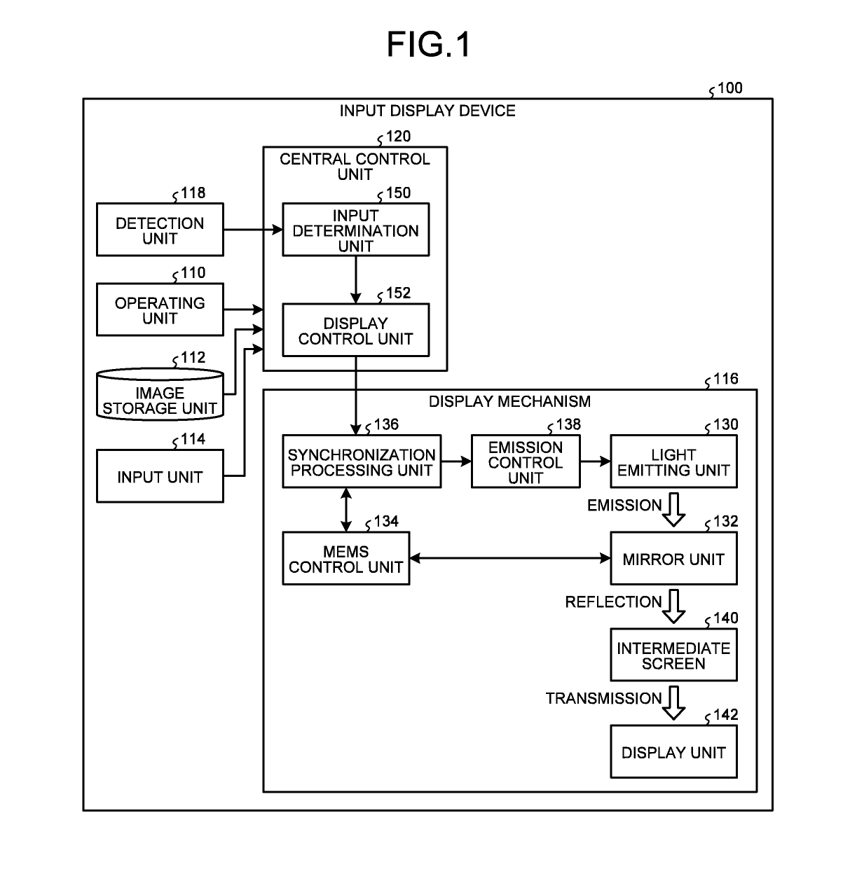

FIG. 1 is a functional block diagram that schematically illustrates an input display device 100. As illustrated in FIG. 1, the input display device 100 includes an operating unit 110, an image storage unit 112, an input unit 114, a display mechanism 116, a detection unit 118, and a central control unit 120. In the present embodiment, an explanation is given of a case where the input display device 100 includes the display mechanism 116 that is configured by using, for example, a Head Up display (HUD).

The operating unit 110 is configured by using an operation key, arrow key, joystick, or the like, so as to receive an input of a user's operation.

The image storage unit 112 is configured by using an electrically erasable and programmable read-only memory (EEPROM), flash memory, hard disk drive (HDD), or the like, so as to store image data. The input unit 114 is an interface for acquiring image data from an external device, such as an image reproduction device.

The display mechanism 116 displays an image on the basis of the image data that is stored in the image storage unit 112 or displays an image on the basis of the image data that is acquired from the input unit 114. Furthermore, the display mechanism 116 displays an image of the application that is executed by the central control unit 120 under the control of the central control unit 120, which will be described later.

Specifically, the display mechanism 116 includes a light emitting unit 130, a mirror unit 132, a Microelectromechanical systems (MEMS) control unit 134, a synchronization processing unit 136, an emission control unit 138, an intermediate screen 140, and a display unit 142.

The light emitting unit 130 is configured by using a laser, for example, so as to emit light for visualizing the virtual image of the image based on image data. The mirror unit 132 is configured by using a plane mirror, concave mirror, or the like, so as to reflect the light emitted by the light emitting unit 130 and guide the light into the intermediate screen 140, which will be described later.

The MEMS control unit 134 controls the orientation of the mirror unit 132. Specifically, the MEMS control unit 134 moves the mirror unit 132 so as to scan the intermediate screen 140 with the light from the light emitting unit 130 in a horizontal direction due to, for example, self-oscillation of a coil and a magnet. Furthermore, the MEMS control unit 134 outputs, to the synchronization processing unit 136, a synchronization signal (e.g., a sine wave) that represents the period of self-oscillation.

The synchronization processing unit 136 then uses the synchronization signal to generate a horizontal synchronization signal that synchronizes with the period of self-oscillation; uses the horizontal synchronization signal to generate a vertical synchronization signal; and then outputs it to the MEMS control unit 134. The MEMS control unit 134 moves the mirror unit 132 so as to scan the intermediate screen 140 with the light from the light emitting unit 130 in a vertical direction in accordance with the vertical synchronization signal.

Furthermore, the synchronization processing unit 136 outputs, to the emission control unit 138, the image data that is output from a display control unit 152, which will be explained later; and the emission timing corresponding to each pixel when the image data is scanned on the basis of the horizontal synchronization signal and the vertical synchronization signal.

The emission control unit 138 causes the light emitting unit 130 to emit light so as to obtain the brightness of each of RGB in accordance with the timing corresponding to each pixel.

The display unit 142 is configured by using a combiner so as to, for example, restrict the wavelength of light that is transmitted or reflected due to the surface coating, thereby transmitting the light from the front (the side opposite to a user with the display unit 142 interposed therebetween) and reflecting, to the back (the side of the user), the light that is emitted by the light emitting unit 130 and is projected onto the intermediate screen 140.

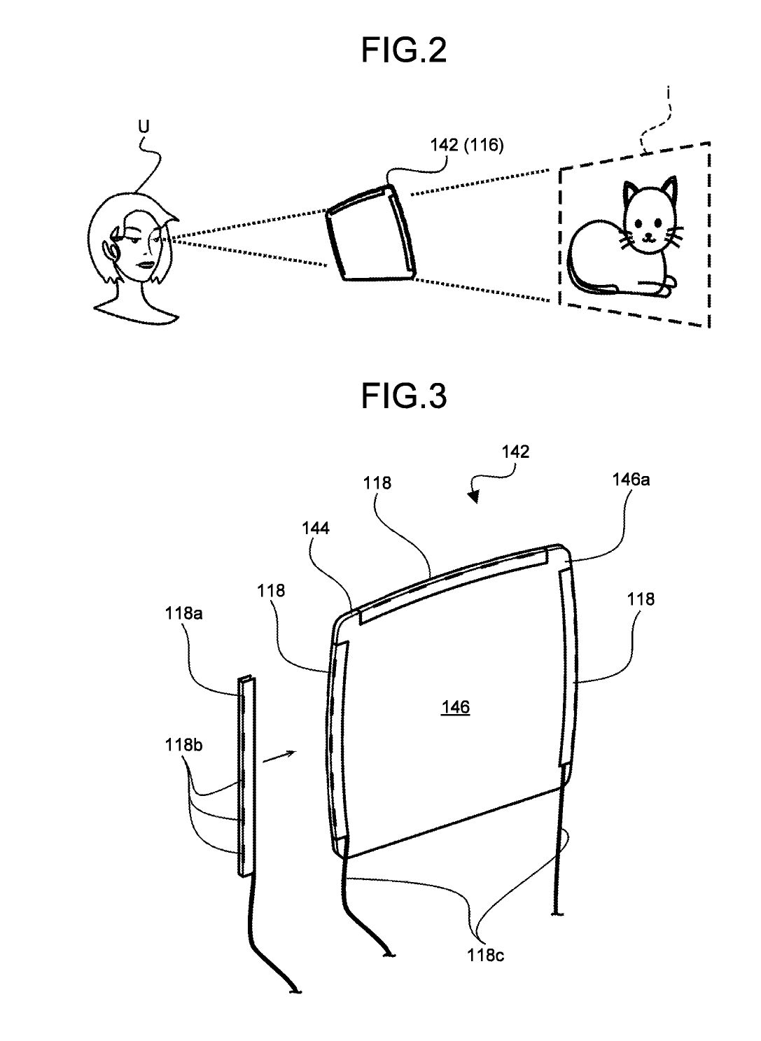

FIG. 2 is an explanatory diagram that illustrates image formation of a virtual image i by using the display mechanism 116. As illustrated in FIG. 2, while a user U turns his/her eyes to the display unit 142, the light from the light emitting unit 130 is reflected by the display unit 142 and is incident on the user U's eyes.

Then, due to the light that is emitted by the light emitting unit 130, the virtual image i of the image on the basis of the image data is formed in an area posterior to the display unit 142 when viewed from the user U, and the user U can view it. Thus, the display unit 142 visualizes the image on the basis of image data (displays the image).

The detection unit 118 is configured by using a capacitive touch sensor so as to detect changes in the capacitance.

FIG. 3 is an explanatory diagram that illustrates the arrangement of the detection units 118 in the display unit 142. As illustrated in FIG. 3, the detection unit 118 is provided on an outer circumference surface 144 that is located on the outer circumference of the display unit 142. Although only a front surface 146 is illustrated here, the back surface has the same appearance as the front surface 146. Furthermore, the display unit 142 may have a concave shape when viewed from the user U.

Moreover, the detection unit 118 is provided on an outer edge portion 146a of the front surface 146 which is a reflectance surface that reflects the light from the light emitting unit 130, and is also provided on the outer edge portion of the back surface that is located on the side opposite to the front surface 146. Here, the outer edge portion 146a is an area that is included in the front surface 146 and extends from the boundary between the outer circumference surface 144 and the front surface 146 toward the front surface 146.

In the present embodiment, the detection unit 118 is configured by using a sensor member 118a of which cross-sectional surface vertical to the longitudinal direction is formed of U-shape, the U-shape being provided as straddling the outer circumference surface 144 of the display unit 142, the front surface 146, and the back surface.

Moreover, the sensor member 118a is provided on the left side, the right side, and the top of the display unit 142. The U-shaped sensor member 118a described above can cover the edge portion of the display unit 142 to protect. Furthermore, a notch 118b is provided on a curved portion of the sensor member 118a so that the sensor member 118a can be easily formed by bending a flat material into a U-shape.

When the detection unit 118 detects a change in the capacitance, the detection unit 118 outputs, to an input determination unit 150 which will be described below via a wire 118c, the change information that indicates the detected position where the change in the capacitance is detected and the magnitude of the change.

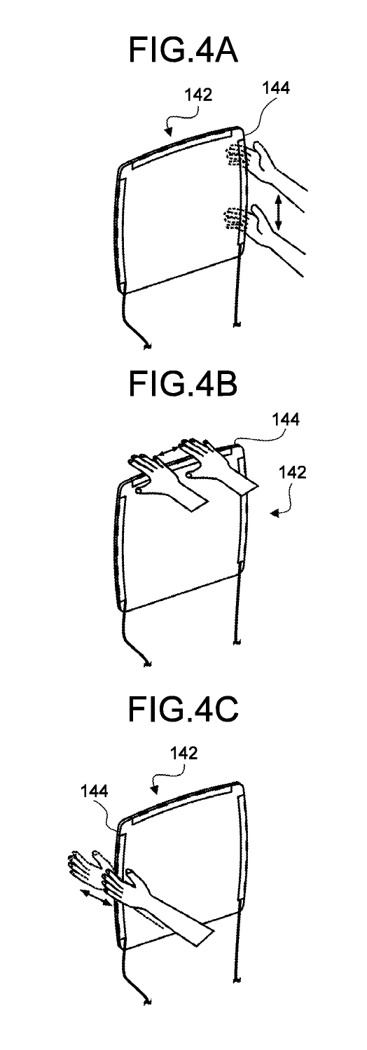

FIGS. 4A to 4C are explanatory diagrams that illustrate a gestural input. The detection unit 118 of the input display device 100 is of a high-sensitive capacitive sensor, so that the detection unit 118 detects a change in the capacitance when one's hand is put close to the detection unit 118 without direct contact thereto. This enables, as illustrated in FIGS. 4A to 4C, an operational input by a gestural input, i.e., by moving one's hand in the vicinity of the detection unit 118.

The capacitance of the area of the detection unit 118 close to the hand changes, and the detection unit 118 detects the change, when one's hand is for example moved in a vertical direction along the outer circumference surface 144 on the right or left side of the display unit 142 as illustrated in FIG. 4A, or when one's hand is moved in a horizontal direction along the outer circumference surface 144 on the top of the display unit 142 as illustrated in FIG. 4B.

For example, in a case where the display mechanism 116 displays an electronic book, an operation is input by the gestural input as illustrated in FIG. 4A, i.e.; moving one's hand downward makes the page go to the next page and moving one's hand upward makes the page return to the previous page. Furthermore, an operation is input by the gestural input illustrated in FIG. 4B, i.e.; moving one's hand from left to right makes the page go to the next page and moving one's hand from right to left makes the page return to the previous page.

Moreover, an operation is input by moving one's hand from left to right close to the outer circumference surface 144 on the left side of the display unit 142, which makes the page go to the next page; and is input by moving one's hand from right to left away therefrom, which makes the page to return to the previous page. In the similar manner, an operation is input by moving one's hand from right to left close to the outer circumference surface 144 on the right side of the display unit 142, which makes the page return to the previous page; and is input by moving one's hand from left to right away therefrom, which makes the page go to the next page.

Furthermore, if the pages of an electronic book are turned over in a vertical direction, an operation is input by moving one's hand downward close to the outer circumference surface 144 on the top of the display unit 142, which makes the page return to the previous page; and is input by moving one's hand upward away therefrom, which make the page go to the next page.

As the above-described gestural inputs correspond to exemplary operations for electronic books, they may correspond to any other operations for electronic books; and an image that is subject to the operations is not limited to an image of the electronic book.

As illustrated in FIGS. 4A to 4C, the input display device 100 according to the present embodiment enables gestural inputs, i.e., moving one's hand along the outer circumference surface 144 of the display unit 142; therefore, compared to a case where the detection unit 118 is provided only on the front surface 146, an operation can easily be input naturally without forcibly bending user's wrist.

Furthermore, as illustrated in FIG. 4C, the input display device 100 according to the present embodiment enables a gestural input by moving one's hand in a front-back direction of the display unit 142 along the outer circumference surface 144 of the display unit 142. In this case, a gestural input in the front-back direction is determined based on the change in the capacitance of the detection unit 118 provided on each area, i.e., the outer circumference surface 144, the front surface 146, and the back surface.

An explanation is given with reference to FIG. 1 again. The central control unit 120 manages and controls the overall input display device 100 and executes applications by using a semiconductor integrated circuit that includes, for example, a central processing unit (CPU), a ROM that stores programs, or the like, and a RAM that is a working area. Furthermore, the central control unit 120 also functions as the input determination unit 150 and the display control unit 152.

Furthermore, when the input determination unit 150 acquires the change information from the detection unit 118, the input determination unit 150 determines the operational input based on the moving direction of which related position's capacitance has been changed (the direction of the change in the detected position), which is indicated by the change information. Moreover, the input determination unit 150 determines the operational input by determining whether the direction of the change in the detected position is in the posterior direction from the side of the front surface 146 of the display unit 142 to the side of the back surface, or in the anterior direction from the side of the back surface to the side of the front surface 146. The input determination process performed by the input determination unit 150 will be explained in detail later.

The display control unit 152 processes the image data, acquired from the image storage unit 112 or from the input unit 114, to make adapt to displaying on the display mechanism 116 or to make adapt to be appropriate for execution by an application based on the operational input so as to output to the synchronization processing unit 136.

Specifically, the display control unit 152 processes an image data, which is for example related to the image data displayed on the displaying unit 142, to zoom in or out in accordance with an input determined by the input determination unit 150.

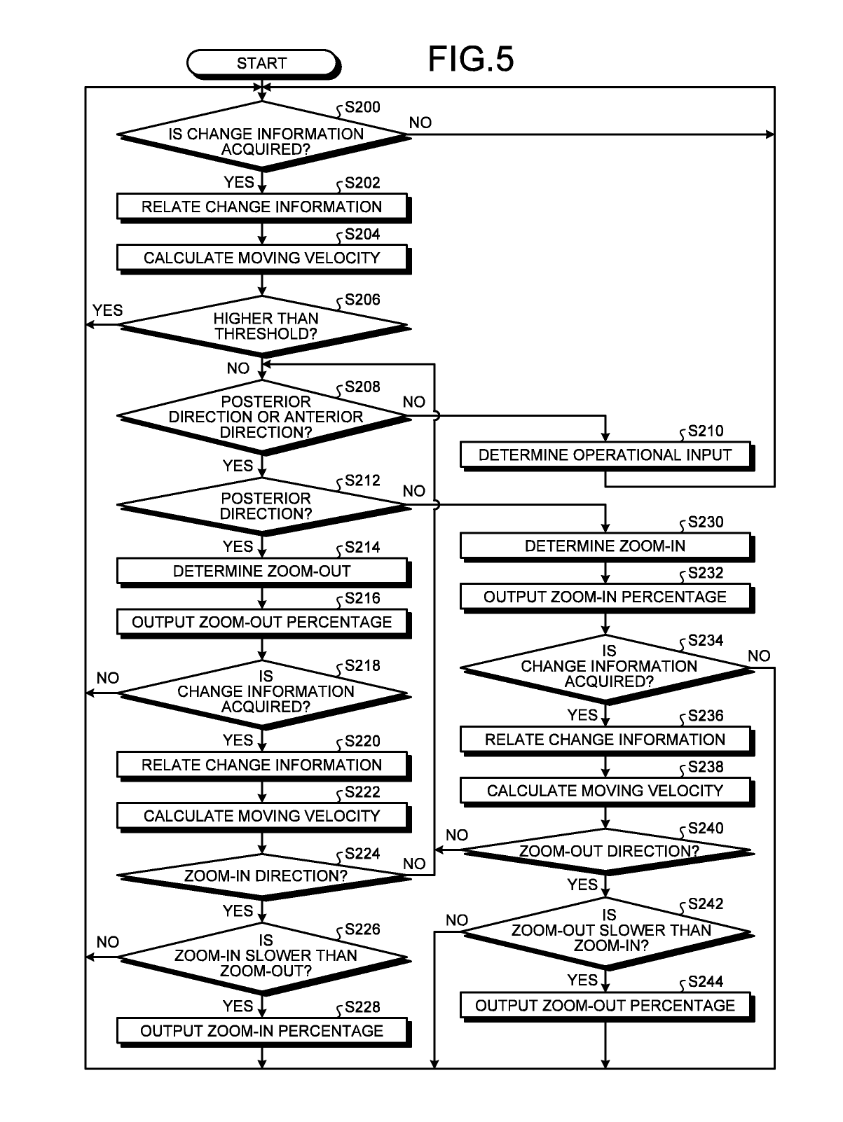

Next, an explanation is given of an input determination method performed by the input determination unit 150 of the input display device 100. FIG. 5 is a flowchart that illustrates the process flow of the input determination method.

As illustrated in FIG. 5, the input determination unit 150 determines whether change information is acquired from the detection unit 118 (S200). If not acquired (No at S200), this acquisition determination process step S200 repeats.

If the change information is acquired (Yes at S200) and if, during a predetermined time elapses after the change information is acquired, change information indicates the same change direction at the capacitance of the surface of the detection unit 118 (the change in the detected position), it is determined that the change information is being continuously acquired. The input determination unit 150 repeatedly determines until no more subsequent change information is acquired within a predetermined time period after the previous change information is acquired, and then relates the series of change information to continuous change information (S202).

Then, the input determination unit 150 calculates the velocity of the positional change of the detection unit 118 based on the distance of the trajectory of the detected position indicated by the continuous change information and the time interval in which the continuous change information is acquired (S204). The velocity of the change in the detected position of the detection unit 118 is the moving velocity of the detected position, and hereinafter it is simply referred to as moving velocity.

Next, the input determination unit 150 determines whether the calculated moving velocity is higher than a threshold of a predetermined value (S206). If determined higher than the threshold (Yes at S206), the input, which is associated with the continuous change information that gives the moving velocity, is not determined as an operational input; and the process returns to the acquisition determination process step S200.

For example, in a case of a gestural input in the direction (in the anterior direction), when viewed from the user U, from the side of the display unit 142 where the user U needs to reach out his/her hand toward the side of the user U, the user U needs to make a gesture after once moving his/her hand in a direction (in the posterior direction) to a position where the user U needs to reach out his/her hand. Therefore, such a movement of his/her hand that is unrelated to an operational input is likely to be mistakenly determined as an operational input. In the present embodiment, if the value of the moving velocity is larger than the threshold, the input determination unit 150 determines that such a change in the detected position is not an operational input. When one's hand is more quickly moved in the posterior direction than the threshold, the input determination unit 150 does not determine as a movement in the posterior direction, which can facilitate a gestural input in the anterior direction.

If the calculated moving velocity is equal to or lower than the threshold (No at S206), the input determination unit 150 determines whether the direction of the detected changed position is in any one of the posterior direction and the anterior direction of the display unit 142 (S208).

If the detected position indicated by the continuous change information crosses the outer circumference surface 144 of the display unit 142 and any one or both of the front surface 146 and the back surface, the input determination unit 150 determines that the direction of the change in the detected position is the posterior direction or the anterior direction. Here, in a case where the detection unit 118 is provided only on the outer circumference surface 144, the passage of one's hand along the outer circumference surface 144 can be determined by using a change in the capacitance. However, it is difficult to determine the direction of the change in the capacitance (the change in the detected position). In the present embodiment, the detection units 118 provided on the front surface 146 and the back surface make it possible to determine whether a gesture input is from the side of the front surface 146 toward the outer circumference surface 144 or a gesture input is from the side of the back surface toward the outer circumference surface 144.

If a shielding member is provided within a typical capacitive touch sensor, a change in the capacitance becomes smaller than in a case without the shielding member. For example, in as case where one's hand is put at the side of the front surface 146, a change in the capacitance of the detection unit 118 on the front surface 146 is larger than a change in the capacitance of the detection unit 118 on the back surface; and, the detection unit 118 has a U-shaped cross-sectional surface so as to advantageously reduce false detection of the gesture direction.

As described above, the input determination unit 150 determines an operational input on the basis of whether it is in the posterior direction or the anterior direction. The input display device 100 can receive an operational input by a gesture with high accuracy, even in a situation where the width of the display unit 142 is restricted small in the front-back direction and a space for the detection unit 118 can not adequately be permitted in the front-back direction for making the design thinner.

If the direction of the change in the detected position detected by the detection unit 118 is neither the posterior direction nor the anterior direction (No at S208), the input determination unit 150 determines that it is an operational input in a vertical direction or in a horizontal direction on the basis of the direction of the change in the detected position (S210). As an operational input in a vertical direction or in a horizontal direction is not related to the feature of the present embodiment, the detailed explanation thereof is omitted. Then, the process returns to the acquisition determination process step S200.

If the direction of the change in the detected position is any one of the posterior direction and the anterior direction (Yes at S208), the input determination unit 150 determines whether the direction of the change in the detected position is the posterior direction (S212).

With regard to the directions of a change in the detected position, one of the posterior direction and the anterior direction is previously set to a zoom-out direction, and the other one of them is previously set to a zoom-in direction. Here, for example, the posterior direction is set to a zoom-out direction, and the anterior direction is set to a zoom-in direction.

In the case of the zoom-out direction (the posterior direction) (Yes at S212), it is determined that an operational input is for zooming out on the image that is displayed on the display unit 142 (S214). Then, the zoom-out percentage of the image is calculated based on the moving velocity in the zoom-out direction, and it is output to the synchronization processing unit 136 (S216).

Then, the input determination unit 150, after having determined that the operational input is for zooming out on the image, determines whether change information is acquired from the detection unit 118 within a predetermined standby time (S218). If the change information is not acquired (No at S218), the process returns to the acquisition determination process step S200. If the change information is acquired (Yes at S218), the series of change information is made related to the continuous change information in the same manner as the relating step S202 (S220). Then, the moving velocity is calculated based on the continuous change information (S222).

The input determination unit 150 then determines whether the direction of the change in the detected position indicated by the continuous change information is the zoom-in direction (the anterior direction) (S224). If determined not the zoom-in direction (No at S224), the process returns to the front-back direction determination step S208. If determined the zoom-in direction (Yes at S224), it is determined whether the moving velocity in the zoom-in direction calculated at the calculation step S222 is lower than the moving velocity in the zoom-out direction calculated at the calculation step S204 (S226).

If the change in the detected position in the zoom-in direction is slower than the change in the detected position in the zoom-out direction (Yes at S226), it is determined that the operational input is for zooming in on the image. The zoom-in percentage is calculated on the basis of the moving velocity in the zoom-in direction, and is output to the synchronization processing unit 136 (S228); and then the process returns to the acquisition determination process step S200.

As described above, if a change in the detected position is detected in one of the posterior and anterior directions and then a change in the detected position is detected in the another one of the posterior and anterior directions, and if the moving velocity of the subsequent change in the detected position is lower than the moving velocity of the previous change in the detected position, the input determination unit 150 determines that the subsequent change in the detected position is an operational input that corresponds to the direction (the posterior direction or the anterior direction) of the subsequent change in the detected position.

If the change in the detected position in the zoom-in direction is equal to or faster than the change in the detected position in the zoom-out direction (No at S226), it is not determined to be the operational input for zooming in on the image, and the process returns to the acquisition determination process step S200.

As described above, if a change in the detected position is detected in one of the posterior and anterior directions and then a change in the detected position is detected in the another one of the posterior and anterior directions, and if the moving velocity of the subsequent change in the detected position is equal to or higher than the moving velocity of the previous change in the detected position, the input determination unit 150 determines that the subsequent change in the detected position is not an operational input.

For example, if the detected position is changed in the zoom-out direction and then the detected position is changed in the zoom-in direction at a moving velocity that is lower than the moving velocity in the zoom-out direction, it is determined to be an operational input for zooming in on the image; thus, it is possible to make a fine adjustment on the image that has been zoomed out too much. However, if the posterior direction is the zoom-out direction, one's hand needs to be put back in an anterior direction after the operational input is finished. At that time, if it is mistakenly determined to be an operational input in the zoom-in direction, the image is repeatedly zoomed in and out. Therefore, in the present embodiment, if one's hand is put back in the anterior direction while the moving velocity in the zoom-in direction (the anterior direction) is equal to or higher than the moving velocity in the zoom-out direction (the posterior direction), the operational input in the zoom-in direction is ignored; thus, if a user puts back his/her hand quickly in the anterior direction, it is possible to prevent the image from being zoomed in without intention.

If the direction of the change at the detected position is not the posterior direction at the change determination step S212 (No at S212), i.e., if it is determined as the zoom-in direction (the anterior direction), the input determination unit 150 determines that the operational input is for zooming in on the image that is displayed on the display unit 142 (S230). The input determination unit 150 then outputs, to the synchronization processing unit 136, the zoom-in percentage of the image on the basis of the moving velocity in the zoom-in direction (S232).

After the input determination unit 150 determines that the operational input is for zooming in on the image, the input determination unit 150 then determines whether change information is acquired from the detection unit 118 within a predetermined standby time (S234). If change information is not acquired (No at S234), the process returns to the acquisition determination process step S200. If change information is acquired (Yes at S234), the series of change information is related as continuous change information in the same manner as the relating step S202 (S236). Then, the moving velocity is calculated by using the continuous change information (S238).

Then, the input determination unit 150 determines whether the direction of the change in the detected position indicated by the continuous change information is the zoom-out direction (the posterior direction) (S240). If it is not determined as the zoom-out direction (No at S240), the process proceeds to the front-back direction determination step S208. If it is the zoom-out direction (Yes at S238), it is determined whether the moving velocity in the zoom-out direction that is calculated at the calculation step S238 is lower than the moving velocity in the zoom-in direction that is calculated at the calculation step S204 (S242).

If the change in the detected position in the zoom-out direction is slower than the change in the detected position in the zoom-in direction (Yes at S242), it is determined to be an operational input for zooming out on the image; the zoom-out percentage of the image in accordance with the moving velocity in the zoom-out direction is output to the synchronization processing unit 136 (S244); and the process returns to the acquisition determination process step S200.

If the change in the detected position in the zoom-out direction is equal to or faster than the change in the detected position in the zoom-in direction (No at S242), it is not determined to be an operational input for zooming out on the image, and the process returns to the acquisition determination process step S200.

As described above, if a change occurs in the detected position in the zoom-in direction and then a change occurs in the detected position in the zoom-out direction at a moving velocity that is lower than the moving velocity in the zoom-in direction, it is determined to be an operational input for zooming out on the image; thus, it is possible to make a fine adjustment on the image that has been zoomed in too much.

Further, in the present embodiment, the posterior direction is defined as the zoom-out direction; however, if the posterior direction is the zoom-in direction, one's hand is put back in the anterior direction after the operational input is finished. At that time, if it is mistakenly determined as an operational input in the zoom-out direction, the image is repeatedly zoomed in and out. Therefore, if one's hand is put back in the anterior direction while the moving velocity in the zoom-out direction (the anterior direction) is equal to or higher than the moving velocity in the zoom-in direction (the posterior direction), the operational input in the zoom-out direction is ignored; thus, if a user puts back his/her hand quickly in the anterior direction, it is possible to prevent the image from being zoomed out without intention.

As described above, the input determination unit 150 determines an operational input for zooming in or out on an image in accordance with a change in the detected position in the anterior direction or the posterior direction; thus, it is possible to perform an operation to zoom in or out on an image in an intuitive way.

Furthermore, in the above-described embodiment, an explanation is given in a case where the input determination unit 150 determines one of the posterior and anterior directions as a zoom-out direction; determines the other one of the posterior and anterior directions as a zoom-in direction; and determines a change in the detected position in the posterior or anterior direction to be an operational input for zooming in or out on an image. However, a configuration may be such that the input determination unit 150 determines changes in the detected position in the posterior and anterior directions to be an operational input for manipulation that can be easily recognized in association with a movement in the front-back direction. In this case, the user U is able to perform an operation in an intuitive way via the detection unit 118.

Furthermore, an optical magnification unit (a typical optical zoom mechanism) may be provided between the intermediate screen 140 and the front surface 146 of the display unit 142, so that a displayed image is zoomed in or out due to the optical magnification in response to a gesture in the front-back direction.

Furthermore, an explanation is given above of a case where the gestures are assigned to operations, on the contents such as images displayed on the display unit 142, i.e., zooming in or out, turning over the pages, or the like; however, an operation may be performed by a gesture to change the image location of the virtual image that is formed in an area posterior to the display unit 142 when viewed from the user U.

For example, an optical mechanism may be provided to change the optical distance (optical path length) from the intermediate screen 140 to the front surface 146 of the display unit 142, thereby increasing the optical path length in response to a gesture toward the back (or toward the front) in the front-back direction so as to shift the image location toward the back side or decreasing the optical path length in response to a gesture toward the front (or toward the back) in the front-back direction so as to shift the image location toward the front side.

For example, an optical mechanism may be provided between the intermediate screen 140 and the front surface 146 of the display unit 142 with the projection light configured to tilt at an angle relative to the optical axis. When a gesture (the action illustrated in FIG. 4B) is made in a horizontal direction on the detection unit 118 provided along the outer circumference surface 144 on the top of the display unit 142, the image location of the virtual image may be moved in a horizontal direction with an angle tilted with respect to the optical axis in a horizontal direction; or when a gesture (the action illustrated in FIG. 4A) is made in a vertical direction on the detection unit 118 provided along the outer circumference surface 144 on the right side or left side of the display unit 142, the image location of the virtual image may be moved in a vertical direction with an angle tilted with respect to the optical axis in a vertical direction.

With regard to the above-described adjustment on the image location of the virtual image, it is possible to move the virtual image more effectively by making further adjustment, i.e., moving the focus position of the concave display unit 142, changing the angle thereof, or moving the installation position thereof.

In the present embodiment, an explanation is given of a case where the detection unit 118 is a capacitive touch sensor; however, any detection units may be used as long as it can determine the detected position that is the position where the amount of detected capacitance, or the like, is changed. For example, it is possible to use contact-type sensors, such as pressure-sensitive sensors or displacement sensors, or non-contact type sensors, such as optical sensors, magnetic sensors, thermal sensors, or wind-pressure sensors. In order to improve the operational performance, when a contact-type sensor is installed, the detection units may be provided such that they are continuously adjacent to each other on the outer circumference surface of the display unit and on the outer edge portion of any one or both of the front surface and the back surface thereof.

The steps of the input determination method described in this specification do not necessarily need to be performed in chronological order in accordance with the flow described in the flowchart, and they may be performed in parallel or may include a process using a subroutine.

Although the preferred embodiment is described above with reference to the attached drawings, it is obvious that the present invention is not limited to the embodiment. It is certain that a person skilled in the art can provide various examples altered or modified within the range described in the scope of claims, and it is certainly understood that they are included in the technical scope of the present invention.

For example, in the above-described embodiment, an example of the display unit 142 is of a combiner of a HUD; however, it may be of a liquid crystal display, organic electro luminescence (EL) display, or the like, if it is capable of visualizing the image based on the image data.

Furthermore, in the above-described embodiment, an explanation is given of a case where the input display device 100 includes the operating unit 110; however, the operating unit 110 may not be provided, and all of the operational inputs may be performed by the detection unit 118.

Moreover, in the above-described embodiment, an explanation is given of a case where the detection unit 118 is provided on the outer edge portion 146a of the front surface 146 and the outer edge portion of the back surface in addition to the outer circumference surface 144 of the display unit 142. However, the detection unit 118 may be provided on any one of the outer edge portion 146a of the front surface 146 and the outer edge portion of the back surface in addition to the outer circumference surface 144.

According to an aspect of the present invention, it is possible to perform an operation in the front-back direction by using a gesture in an intuitive way.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An input display device comprising:
a display unit configured to display an image in a front surface thereof;
a detection unit configured to be provided on an outer circumference of the display unit; and
an input determination unit configured to determine a detected position detected by the detection unit is changed whether
in a posterior direction from a side of the front surface of the display unit to a side of a back surface of the display unit, or
in an anterior direction from the side of the back surface to the side of the front surface.

2. The input display device according to claim 1, wherein
the detection unit is provided
on the outer circumference of the display unit and
on any one or both of the front surface and the back surface of the display unit.

3. The input display device according to claim 1, further comprising
a display control unit configure to perform image processing to zoom in or zoom out on the image displayed on the display unit, wherein
the input determination unit
defines
one of the posterior direction and the anterior direction as a zoom-out direction and
another one of the posterior direction and the anterior direction as a zoom-in direction, and
the display control unit
causes the display unit to zoom out the displayed image when a change in the zoom-out direction at the detected position is detected, and
causes the display unit to zoom in the displayed image when a change in the zoom-in direction at the detected position is detected.

4. The input display device according to claim 1, wherein
the input determination unit
calculates a velocity of a change at the detected position, and,
if a change at the detected position is detected in one of the posterior direction and the anterior direction, and then further a change at the detected position is detected in the another one of the posterior and anterior directions, and if the velocity of a subsequent change at the detected position is lower than the velocity of a previous change at the detected position, determines the subsequent change at the detected position as an operational input that corresponds to a direction of the subsequent change at the detected position.

5. The input display device according to claim 1, wherein
the input determination unit
calculates a velocity of a change at the detected position, and
if a change at the detected position is detected in one of the posterior direction and the anterior direction, and then further a change at the detected position is detected in the another one of the posterior and anterior directions, and if a velocity of a subsequent change at the detected position is equal to or higher than a velocity of a previous change in the detected position, does not determine the subsequent change at the detected position as an operational input.

6. The input display device according to claim 4, wherein
if the velocity of the previous change at the detected position is higher than a predetermined value, the input determination unit determines the previous change at the detected position as not an operational input.

7. The input display device according to claim 5, wherein
if the velocity of the previous change at the detected position is higher than a predetermined value, the input determination unit does not determine the previous change at the detected position as an operational input.

8. The input display device according claim 1, wherein
the detection unit detects a position of which capacitance is changed as the detected position.
